(19) United States
(12) Patent Application Publication
(10) Pub. No.: US 2008/0237937 A1
(43) Pub. Date: Oct. 2, 2008

(54) Means and Method for Producing Enhanced Object Gripping Surfaces and Enhancing Object Strength, and The Objects So Enhanced

(76) Inventor: Ben Aaron, Forestville, NY (US)

Correspondence Address: PATRICIA M. COSTANZO;PATS PENDING, P.O. BOX 101, ELMA, NY, 14059, US

(21) Appl. No.: 12/137,716

(22) Filed: Jun. 12, 2008

Related U.S. Application Data
(63) Continuation-in-part of application No. 11/067,238, filed on Feb. 26, 2005.

(51) Int. Cl. B29C 35/08; A63B 59/06

(52) U.S. Cl. 264/494; 264/36.22; 264/257; 473/568; 473/564; 473/566

(57) ABSTRACT

A process for enhancing a gripping area of an object, providing a frictionally enhanced, moisture repellent, sure-grip gripping surface, achieved by less than one second ultraviolet radiation curing of an ultraviolet-curable coating applied over polymeric fibers enveloping the gripping surface of the object. This inexpensive three step process uses commonly available, low-cost materials, minimal energy, is environmentally friendly, does not require repeated steps, thermosetting, vulcanization, caustic chemicals, molds, molding techniques, and gluing a molded cover onto a surface. Also, metallicized objects where metallicizing imparts superior strength to objects reducing or eliminating breakage and/or splintering when impacted, by a ball if object is a bat reducing or eliminating potential lethal hazards often imparted to a ball when hit by aluminum bats.

### CROSS-REFERENCE TO RELATED APPLICATIONS

This Application claims the benefit of application Ser. No. 11/067,238 filed on Feb. 26, 2005.

### STATEMENT REGARDING FEDERALLY SPONSORED RESEARCH OR DEVELOPMENT

Not Applicable

### REFERENCE TO SEQUENCE LISTING, A TABLE OR A COMPUTER PROGRAM LISTING COMPACT DISK APPENDIX

Not Applicable

### BACKGROUND

The present invention relates generally to objects having a gripping surface and to objects that would benefit from added surface strength, and more particularly to means and methods for manufacturing an enhanced gripping surface on objects that require gripping and for adding surface strength to objects.

The background information discussed below is presented to better illustrate the novelty and usefulness of the present invention. Wooden bats for playing baseball and softball along with other items are used throughout the document as examples to facilitate the full, clear, and concise description of the invention so as to enable any person skilled in the art to make and use the invention. Thus, this background information is not admitted prior art and it is to be understood that the teachings are not confined to the examples used.

Baseball and softball have been traditionally played with a wood bat; however, for reasons discussed below there has been an increased use of aluminum bats by many players. Although major baseball teams still only use wooden bats, professional and amateur softball leagues, baseball and softball college leagues, high school baseball and softball leagues, and little league baseball and softball teams mostly use aluminum bats. Concern regarding the hazards of using aluminum bats in the game of baseball, however, is growing.

Baseball bat manufacturers, through advances in technology, are making aluminum bats that meet the required measurement and size standards of typical wooden baseball bats, but are much stronger and lighter in weight than their wooden counterparts. Lighter bats allow for faster bat speeds during swings that result in hit-ball velocities that can present lethal hazards to players due to the high velocities imparted from the bat to a ball as the bat strikes the ball. This is prompting some athletic committees and baseball leagues to ban the use of these bats. In fact, in 2003 the baseball committee of the Massachusetts Interscholastic Athletic Committee voted 9-6 to ban aluminum bats and recommended that only wooden bats be used at all levels of play beginning in 2004.

Although potential risks of injury, including fatal injuries, to both players and spectators are the most important concern, there are other reasons for using wooden bats. Studies show that when using an aluminum bat, a hitter can make contact between the ball and the bat at almost any point on the bat and achieve the same result as if he or she had hit the ball with the very restricted “sweet spot” area of a wooden bat. In fact, over the last few years, it has been reported that batting averages, scoring, and home runs have all increased in NCAA baseball, and that aluminum bats are being credited with distorting the development of college pitchers who have to use drastically different strategies when pitching against players using aluminum bats than they would if they were pitching against players using wooden bats. Thus, the transition from college-level pitching to professional-level pitching, where only wooden bats are allowed, becomes extremely difficult. It is felt by many that banning aluminum bats in the NCAA at the Division I level would help college baseball players become better prepared for a future in professional baseball

While many ball players welcome a ban on the use of aluminum bats, others do not want to ban the use of aluminum bats because of the lack of strength of wooden bats. Wooden bats are known to have a weak area located just above the gripping area. It is here that wooden bats tend to break as the bat hits a ball when the bat's swinging speed reaches about 72-75 mph. When a wooden bat breaks, perhaps precipitated by an unseen flaw or weakness in the wood grain, the section that breaks away becomes a projectile that may hit and injure a player or spectator. Moreover, many splinters can form from the break, and these, too, may also result in injuries. It is believed that when bats break upon impact, it is because wood does not have the strength exhibited by an aluminum bat when a ball impacts the bat.

Some of those involved in the game argue that even though aluminum bats pose serious risks to players and spectators, it is just too costly to use wooden bats. Aluminum bats generally last from three to five seasons, while wooden bats often do not last even one season. It is not unusual for professional players to go through several dozen wooden bats each season. Similarly, college teams that use wooden bats often break more than two dozen bats during a season. Wooden bats, partly due to the amount of breakage and replacement required because of the breakage, and to the increasing shortages of quality wood, generally cost considerably more per season than aluminum bats. It is estimated that, on average, a college team might use twelve aluminum bats per season, compared to more than five dozen wooden bats. The cost of wooden bats added to the fact that wooden bats need frequent replacement because of their relatively lower strength as compared to an aluminum bat, makes the use of risk-posing aluminum bats instead of safer to use wooden bats somewhat understandable.

Regardless of the type of bat used, aluminum or wood, a related problem that is faced by ball players is the too frequent loss of the batter's grip on the bat during a game. A sure grip on the bat increases the accuracy of the play. A surer grip allows the player to hold the bat less tightly, thus, increasing the player's efficiency of movement making it less likely that the player will strain his muscles. In addition, a sure-grip decreases the danger of having the bat slip out of the player's hands. And, of course, smooth metal bats are extremely slippery, as are wooden bats that have a highly polished surface.

A sure grip is important, not only for baseball and softball bats, but is important for any gripping surface. Gripping surfaces are found on a multitude of objects, such as on the handles of hand tools, such as hammers, screw drivers, hatchets, as well as on ladder rungs, on sports equipment, such as golf clubs, baseball bats and tennis, and on medical devices, such as walkers and canes. It is easy then to appreciate how desirable it is to provide for a sure-grip surface on such handles.

It is known that one's grip can be improved by adding a layer of a malleable material to a hard handle, for example by wrapping the handle with fabric or leather tape or by encasing the handle in a molded rubber or plastic grip. Alternatively, it is known to improve ones grip by wearing a glove made of relatively soft material, such as a glove made of fabric, leather, rubber or plastic. Ball players often use batting gloves to increase their gripping control. Aluminum bat gripping surfaces can be found made of leather or a synthetic, wrapping grip that tends to become slippery, especially from the sweaty hands of batters or from rain. When players use wooden bats, a gripping additive, such as pine tar is often used in conjunction with batting gloves in order to achieve a better grip on the wooden bat. The use of tar however often results in the player's hand's being left with tar residue. Alternatively, ball players often use tape as a bat grip, but the tape quickly becomes worn out and requires frequent replacement. Other attempts to provide for an enhanced gripping surface include a method that requires an expensive, time and labor intensive, environmentally unfriendly rubber vulcanization process. Another attempt requires expensive coatings made from an expensive and time and labor intensive method requiring relatively rare carbon and aramid fibers that must be braided exactly to certain braiding angles before being trimmed and applied to a surface that is then coated with a first resin for a first thermoset setting (note the first resin must be generously applied to ensure complete coverage about the braided fibers and then the excess must be scrapped off and discarded) for 10 to 15 minutes at 160-180 degrees F., removed from the oven, the fibers must now be trimmed again while on the bat, and additional thermo-curable material is now applied for a second curing which is either a room temperature cure for eight hours or another thermoset cure can be used to shorten the final curing time, in either case the bats should be kept in a vertical position to produce a roughed surface that may require sanding. Yet still another attempt requires a completely separate mold and molding step for the molding manufacture of a blanket-like wrap with finger-like protrusions on one side of the wrap, after this molder material is set, it must be removed from the mold, sized and cut for wrapping about a surface requiring a grip, and then gluing the wrap to surface. All of these attempts leave much to be desired, namely ease of fabrication, low cost, a rapid manufacturing method, and low or no impact to the environment,

Therefore, it is clear that there is a critical need for a means and a method to strengthen objects, as the example bats discusses above that would benefit from such strengthening, as well as for providing a means and method to make an enhanced sure grip gripping surface about both such strengthened objects and any object that requires gripping. The exemplar wooden bats improved by such means and methods are less likely to present lethal hazards to players due to the high velocities imparted from the bat to a ball as occurs when an aluminum bat strikes the ball. Moreover, such an improved bat would possess greater strength in the area that is generally affected upon impact by a ball, so that the bat is less likely to break or splinter when struck. Thus, such an improved bat would reduce the lethal hazards presently posed to players and spectators by the high velocities imparted from the striking bat to the hit ball, while providing the strength and durability required for a bat not to break upon impact with the ball, and would additionally offer an enhanced non-slip, extremely durable gripping surface for the gripping part of the handle. Moreover, such means and methods should offer all of these improvements in a cost effective manner. What is more, the means and method of providing for increased strength to an object that would benefit from an increase in strength and an enhanced sure-grip gripping surface should be applicable for a multiple of devices that are different from bats, but also require improved body strength and improved grip-ability on their gripping surfaces. Such devices include any hand-held tools, such as a hammer or the rungs of a ladder, for example; other sport equipment, such as tennis rackets, bar bell-type lifting weights, and golf clubs, health and safety devices, such as walkers and canes, and medical devices that require a sure grip, to name just a few. Moreover, enhanced sure grip gripping surfaces should be inexpensive to fabricate, the method of fabrication should be rapid, the materials required should be commonly available and low-cost and there should be low or no impact to the environment in the production of the sure-grip gripping surface.

### SUMMARY

Accordingly, the present invention overcomes all of the above described disadvantages and more by providing for a means and a method of enhancing the surface strength of objects that would benefit from added strength and a means and a method of providing for an enhanced sure-grip gripping surface on objects that are required to be gripped.

Wooden bats, strengthened by the means and method provided by the present invention may now be used to avoid the high risk of serious injury that currently plagues both players and spectators due to the high velocities imparted from an aluminum bat to a ball as the bat strikes the ball. Moreover, the strengthened wood bats break and splinter far less frequently, if at all, compared to un-strengthened bats when hit with a high speed ball.

Baseball bats may also be used as examples of objects that require an enhanced sure grip gripping surface, as provided by the invention herein. The enhanced increased friction sure grip surface can be added as a step in the manufacture of objects, such as baseball bats, or may be added to any bat when an enhanced friction sure grip, moisture repellent, gripping surface on the gripping part of the bat handle is desired. A preferred method of making the enhance sure grip gripping surface is by the nearly instantaneous UV energy curing of an inexpensive and readily available UV-curable coating that is applied over an inexpensive and readily available polymer mesh-like material, such as nylon, or where stretch is desired, a nylon and spandex composite material, positioned about the gripping part of the bat handle to produce a polymerized coating permanently bonded to the gripping area. Thus, the present invention teaches both the method to make and means used to make an enhanced sure grip surface for any object that must be gripped, where the enhanced sure grip surface is easily and rapidly manufactured using materials that are commonly available and low-cost, and have a low, or no, impact on the environment. The enhanced sure grip surface when applied to a baseball bat, reduces or eliminates, the otherwise too frequent loss of the batter's grip on the bat during a game as the resulting sure-grip, moisture repellent surface is not affected by moisture such as the perspiration on a user's hands, thus increasing the accuracy of the play. A surer grip allows a player to hold the bat less tightly, thus, increasing the player's efficiency of movement making it less likely that the player will strain his muscles. In addition, a sure-grip decreases the danger of having the bat slip out of the player's hands and. Thus, relieves a batter's apprehension of having his hands slip over the gripping surface of a bat. The gripping area of a baseball bat frequently becomes slippery from the perspiration on the hands of batters, especially during heavy play on a warm day. And, of course, the enhanced sure grip surface is especially appreciated on smooth metal bats that are extremely slippery, as are wooden bats that have a highly polished surface, and is especially ideal for use on low-end bats, such as those bought for home or for school or Little League use.

Furthermore, the means and method of enhancing the surface strength of an object according to the principles of the present invention described herein is available for use with any object that would benefit from an increase in strength. Such devices include any hand-held tools, such as hammers or the rungs of a ladder; other sport equipment, such as tennis rackets, bar bell-type lifting weights, and golf clubs, health and safety devices, such as walkers and canes, and medical devices that require a sure grip, to name just a few. A first preferred form of the enhanced surface strength part of the present invention provides for a way to strengthen objects that will benefit from an addition of increased strength and the objects so strengthened. The way to strengthen objects involves metallicizing such objects by applying a metal powder containing paint to such objects as, for example, a wooden baseball bat, where the coating that metallicizes the bat imparts strength to the bat, reducing breakage and splintering upon impact by a ball. If the object that is strengthened is an object other than a bat, the method of the present invention provides for a reduction in breakage and/or splintering in that object, as well. In addition to increasing the strength of a wooden bat, metallicizing a wooden bat according to the principles of the present invention, reduces or eliminates the potentially lethal hazards suffered by ball players from the high velocities imparted to a ball from a metal bat when the aluminum bat produces a high-velocity ball. The present invention offers the added benefit of producing objects that are stronger and safer while maintaining general affordability.

A third preferred form of the present invention is any object that has both its surface strength enhanced and it gripping area enhanced with a high friction, moisture repellent, sure grip gripping surface. Surfaces that would benefit from the application of both an enhanced surface strength and an enhanced sure-grip gripping surface include surface found on any type of handle including handles on sports equipment, work equipment, household equipment, medical equipment, or the like, ladder rungs, bar bell gripping surfaces, and even on aluminum bats, for example.

These and other benefits of the present invention are made available by providing for a metallized object, the object made stronger by the metallicizing, comprising:

a) an object to be made stronger,

b) a metal powder paint for coating the object, and

c) a coating of the metal powder paint on the object to be made stronger, thus imparting superior strength to the object thereby providing for reduced breakage and splintering of the metallicized strengthened object.

The metal powder paint further comprises stainless steel powder paint. The object to be strengthened is any object that will benefit from being strengthened, including those objects made of wood. An exemplary object made of wood may further comprise a bat for hitting balls. Moreover, the object that benefits from being strengthened according to the principles of the present invention may be made of other materials, such as plastic.

Additionally, objects that require being gripped are offered enhanced, moisture repellent, high friction, sure grip gripping surfaces by making available the method comprising the steps of ultra-violet radiation curing of a coating of ultraviolet-curable, liquid polymer after it is applied over polymeric fiber material placed on the gripping area, therein providing for polymerized coating permanently bonded to the gripping area providing for a high-friction sure-grip gripping moisture repellent surface. Moreover, the object benefiting from being provided with a sure-grip gripping polymerized coating permanently bonded to the gripping area, may be an object made of any material, strengthened or un-strengthened, and also may be made of a metal. Furthermore, in one preferred embodiment, the polymeric fiber material is nylon or a nylon/spandex composite material. Regardless of the type of polymeric material used to envelope the gripping surface of an object, the material may be provided in easy to use tubular form.

The invention also provides for a method for metallicizing an object made stronger by metallicizing, the method comprising the steps of:

a) providing an object to be made stronger,

b) providing a metal powder paint for coating the object, and

c) coating the metal powder paint on the object to be made stronger imparting superior strength to the object providing for reduced breakage and splintering of the metallicized strengthened object. An object that is strengthened by the method for metallicizing an object can also be provided with an enhanced, high friction, sure-grip gripping surface that comprises ultra-violet radiation curing of a coating of ultraviolet-curable liquid coating applied over polymeric fibers that envelop the gripping area to be enhanced providing for a moisture repellant, high-friction, sure-grip gripping surface.

The invention also provides for a method of providing for a sure-grip gripping surface on a gripping area of an object, the method comprising the steps of:

a) providing an object having a gripping area,

b) placing polymeric nylon fibers about the entire gripping area

c) coating said placed about the entire gripping area polymeric nylon fibers with a liquid ultraviolet-curable coating for less than one second, and

d) curing said ultraviolet-cured coating said polymeric fibers using ultra-violet radiation providing for an enhanced high-friction sure-grip gripping surface that is moisture repellent. The object can be any object having a gripping area, the polymeric fibers placed about the entire gripping area can be, for example, a mesh-like nylon, or where extra give is desired a nylon/spandex composite material. Any polymeric material may be use as long as the polymeric fibers are able to polymerize with the ultraviolet-cured coating. The polymeric material is useful when is offered as a tube of material. The ultraviolet curing is almost instantaneous taking place in less than one second.

Still other benefits and advantages of this invention will become apparent to those skilled in the art upon reading and understanding the following detailed specification and related drawings.

### BRIEF DESCRIPTION OF THE DRAWINGS

In order that these and other objects, features, and advantages of the present invention may be more fully comprehended and appreciated, the invention will now be described, by way of example, with reference to specific embodiments thereof which are illustrated in appended drawings wherein like reference characters indicate like parts throughout the several figures. It should be understood that these drawings only depict preferred embodiments of the present invention, such as depicting a wooden baseball bat as an example of an object that would benefit from being strengthened by metallicizing and by using a wooden and a metal baseball bat as examples to illustrate an object improved by provided by being provided with a sure-grip, extremely durable gripping surface that is moisture repellent. Thus, accepting that these examples are not to be considered as limiting the scope of the invention the invention now will be described and explained with additional specificity and detail relating to baseball bats through the use of the accompanying drawings, in which:

FIG. 1 is a partial perspective view of a Prior Art wooden bat.

FIG. 2 is a partial perspective view of a Prior Art metal bat.

FIG. 3 is a partial perspective view of a metallicized wooden bat.

FIG. 4 is a partial perspective view of a metallicized wooden bat with a sure-grip gripping surface on its handle part.

FIG. 5 is a partial perspective view of a wooden bat with a sure-grip gripper surface on its handle part.

FIG. 6 is a partial perspective view of a metal bat with a sure-grip gripper surface on its handle part.

FIG. 7 is a cross-section view of a metallicized wooden bat.

FIG. 8 is a cross-section view of a bat handle with a sure-grip gripper surface.

FIG. 9 is a cross-section view of a metallicized bat having a sure-grip gripper surface handle.

### DEFINITIONS

Gripping surface, as used herein, refers to that surface part of an object by which the object is gripped. Some common gripping surfaces include the handle holding part of a baseball bat, the holding part of a hammer handle, ladder rungs, tennis racket handles, and so on.

Metal powder paint, as used herein, refers to known paints containing metal particles of varying sizes, densities, and shapes. One such metal powder paint comprises platy-shaped particles to provide for the overlap of the particles at the surface of the paint layer thereby creating a smooth and full-coverage metallic surface.

Metallicized, as used herein, refers to an object that has been painted, i.e., coated with metal powder paint.

Nylon, as used herein, refers to any of a family of high-strength, resilient synthetic polymers, the molecules of which contain the recurring amide group CONH. Nylon is produced by chemical synthesis from compounds readily available from air, water, and coal or petroleum and is used to form fibers to be manufactured into yarn and textiles. It has high resistance to wear, heat, and chemicals. Most applications are in the form of filaments in such articles as hosiery, parachutes, and outerwear.

Polymeric fibers, as used herein, refer to natural and synthetic fibers, including but not limited to cotton, silk, wool, rayon, acetate, nylon, spandex, polyethylene terephthalate, acrylics, polyurethanes, and polypropylene, for example. The fibers may be applied to a gripping area of an object in any functional manner, including but not limited to: applying the polymeric fibers in the form of fabric, such as a mesh, spinning fibers about the object, spray coating, and the like.

Stainless steel powder paint, as used herein, refers to any metal powder paint made with stainless steel powders, where the powdered grains of various stainless steels are of varying sizes, densities, and shapes.

Strength, as used herein, refers to the quality or state of being strong in that there is a significant capacity for exertion or endurance and the power to resist force. Therefore, an object that exhibits increased strength exhibits increased solidity and toughness. Strength also includes the meaning given when used as an industrial quality that is, a quality of having more than usual power or durability.

Sure-grip gripping surface, as used herein, refers to the gripping surface part of an object by which the object is gripped where the gripping surface has been enhanced to provide for a moisture repellent, high friction, sure grip surface coating. Some common gripping surfaces that benefit from having a sure grip gripping surface include the handle holding part of a baseball bat, the holding part of a hammer handle, ladder rungs, tennis racket handles, and so on.

Ultraviolet (UV)-curable coating, as used herein, refers to UV-curable coatings comprising a polymeric mesh fabric overlaid over a gripping surface coated with a UV-curable liquid polymer. In a preferred embodiment the polymeric mesh fabric is nylon, and in another preferred embodiment the polymer material is a nylon/spandex composite.

Ultraviolet-cured coatings as used herein, refers to acrylated formulations of silicones, ultraviolet-cured urethanes, and methacrylates, as well as to combined ultraviolet-heat-curing formulations and other chemical systems that are “set” or “cured” using UV-radiation.

Ultraviolet (UV) radiation, as used herein, refers to the portion of the electromagnetic spectrum that extends from the violet, or short-wavelength, end of the visible light range to the X-ray region. UV radiation is undetectable by the human eye. UV radiation lies between wavelengths of about 400 nanometres (1 nanometre [nm] is 10⁻⁹ metre, or 10 angstrom units) on the visible-light side and about 100 nm on the X-ray side, though some authorities extend the short-wavelength limit to 4 nm. In physics, ultraviolet radiation is traditionally divided into four regions: near (400-300 nm), middle (300-200 nm), far (200-100 nm), and extreme (below 100 nm).

### REFERENCE NUMERALS AND THE PARTS OF THE INVENTION TO WHICH THEY REFER

10 A metallicized wooden bat made according to the principles of the invention as described herein.
12 A metallicized surface on a wooden bat.
14 A gripping surface of metallicized wooden bat 10.
16 A sure-grip surface on gripping surface 14.
16b UV-curable coating securing sure-grip surface.
22 Body of a wooden bat.
30 Body of a metal bat.

It should be understood that the drawings are not necessarily to scale. In certain instances, details which are not necessary for an understanding of the present invention or which render other details difficult to perceive may have been omitted.

### DETAILED DESCRIPTION

Referring now, with more particularity, to the drawings, it should be noted that the disclosed invention is disposed to embodiments in various sizes, shapes, and forms, and especially of many objects that are related by their need for increased strength and/or their need for a sure-grip gripping surface. Therefore, it is to be understood that the baseball bat embodiments described herein are provided to be illustrative and thus, their use is not intended to limit the invention to these embodiments.

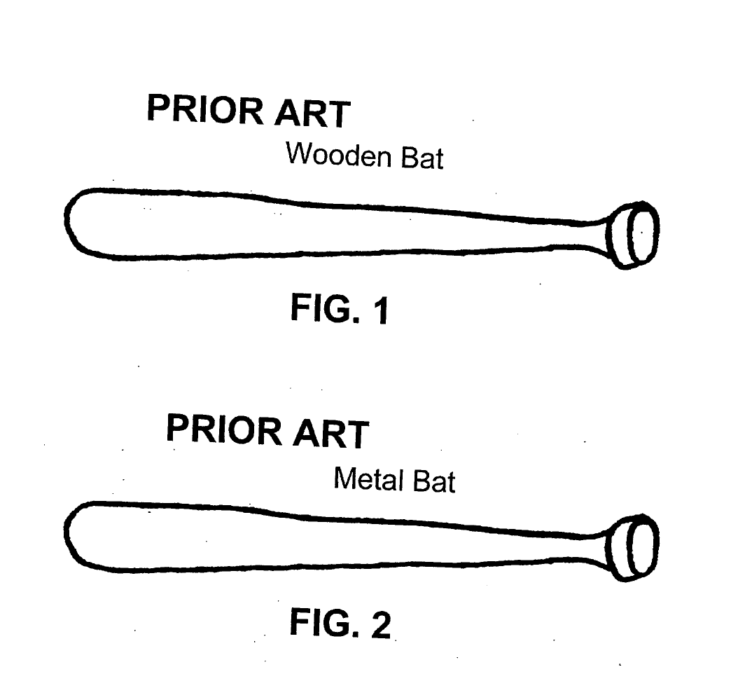

For many objects, wood is the manufacturing material of choice. One such wooden object is illustrated in FIG. 1, a partial perspective view of a Prior Art wooden bat. Problems may arise however when the strength of the object is a consideration. For example, because of the frequent breakage or splintering of conventional wooden baseball bats when hit by a high speed ball, many baseball players have chosen to use bats made of aluminum. FIG. 2, a partial perspective view of a Prior Art metal bat, illustrates a conventional aluminum bat. Aluminum bats, however, are not only expensive, they, more importantly, introduce a serious risk of injury, and in some instances a lethal risk, to both players and spectators of ball games. This risk is created by the extremely high velocities that are imparted to a ball as the ball is struck by an aluminum bat.

To alleviate such problems, the present invention is directed towards the making of a metallicized object, such as a metallicized wooden baseball bat that exhibits increased superior strength compared to the strength of the object before it was metallicized, yet maintains its other desirable properties. In addition to exhibiting superior strength, metallicized objects made according to the principles of this invention are provided with a gripping area having an extremely durable and high-friction sure-grip gripping surface coating that is moisture repellent.

Still other benefits and advantages of this invention will become apparent to those skilled in the art upon reading and understanding the following detailed specification and related drawings.

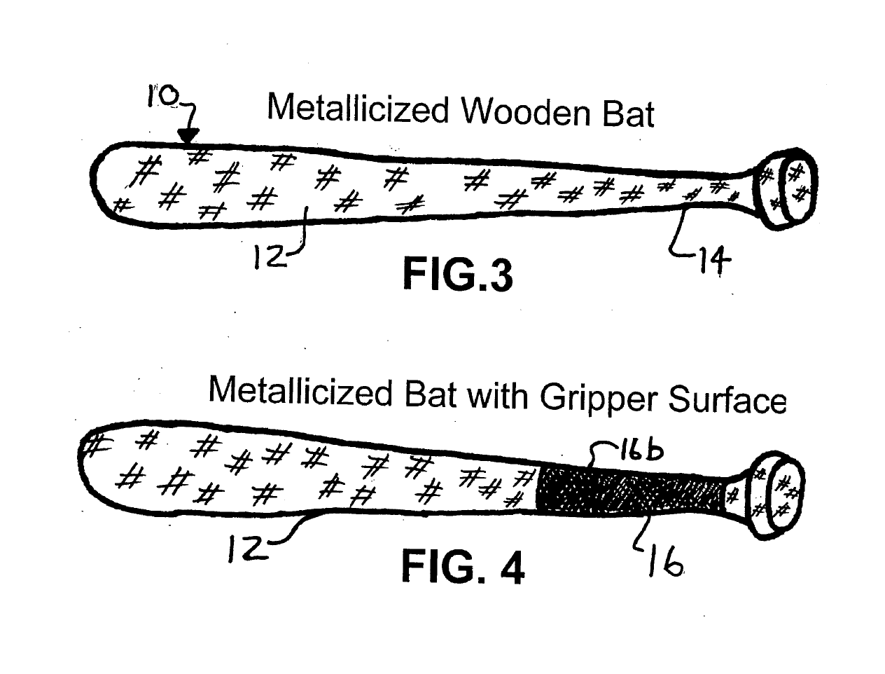

FIG. 3, a partial perspective view of a bat made according to the principles of the invention as described herein, illustrates metallicized wooden bat 10 (where the hatches in the figures indicate a metallicized surface). Metallicized surface 12 may be applied to the entire surface of any object that benefits from the increased strength acquired when metallicized, such as metallicized bat including gripping area 14. Alternatively, metallicization may be limited to only those surface areas that require strengthening. Combining the aesthetic benefits of a cool metallic sheen of the metallicized part of the surface with the warm and natural look of un-metallicized wood is yet another option.

An object is made stronger by metallicizing, that is when a metal powder paint for coating the object is applied to the surface of that object. The superior strength imparted to the object by a coating of the metal powder paint provides for reduced breakage and splintering of the metallicized strengthened object. The metal powder paint may be applied by any known, or yet to be known, method, including, but not restricted to spray painting, vapor deposition, or a brush-type application. An exceptional increase in strength is achieved by a single application of the metal powder paint to the surface of the object to be strengthened, although, if desired, additional applications may be applied for additional strength imparting benefits.

The metal powder paint may comprise, but is not limited to, a stainless steel metal powder paint. Other metal powders may also be used. Many other metals have strengthening properties superior to stainless steel, but cost may be an important factor in deciding which metal powder will provide the most benefit. The stainless steel, or other metal, powder may be of any desired functional composition. The metal particles may be platy (i.e., have a flake-like morphology where the surface area of the particle is large but the thickness of the particle is only a very small fraction of the surface area of the particle) to achieve maximum coverage or of any other desired functional shape and may also have any desired functional size and density.

The object to be strengthened is any object that benefits from being strengthened, and includes objects made of wood. Herein, while a bat is used as an exemplary object made of wood, other objects that benefit from being strengthened according to the principles of the present invention may be made of materials, such as plastic, fiberglass, plaster, or glass.

A baseball bat, while serving as an example of an object that is strengthened by the method for metallicizing an object according to the teaching of the present invention, also can serve as an example of an object having a gripping area that would benefit from having an enhanced, high-friction, moisture repellent, sure-grip gripping surface applied, when the object is a baseball bat to provide a batter with a safe and sure grip when he or she is using the bat. For example, gripping surface are 16, as illustrated in FIG. 4, is a sure-grip gripping surface. Basically, enhanced sure-grip gripping surface 16 is prepared by first placing polymeric fibers, such as nylon or a composite of nylon and spandex whenever more elasticity is required, over a gripping area, applying an ultraviolet-curable coating over said polymeric fibers, and using ultraviolet radiation to cure, almost instantaneously—in a second or less, the ultraviolet-cured coating over the polymeric fibers providing for an extremely durable and high-friction sure-grip gripping surface that is moisture repellent. This simple, rapid, and inexpensive three step process using commonly available, low cost materials, that do not require repeated steps, thermosetting, excess materials that have to be scraped off, repeat trimming, vulcanization methods, caustic chemicals, molds, molding techniques, and gluing a covering onto the gripping surfaces, results in providing for an enhanced high-friction, sure-grip gripping surface that is moisture repellent and much easier on the environment and the use of energy.

Various coatings previously used in the preparation of gripping surfaces for baseball bats include lacquers, epoxy systems, and urethanes, e.g., one-part air-dry systems, two-part urethane, two-part epoxy, and baking systems. Many of the presently available grip devices that are made using these known systems are negatively affected by moisture, including perspiration, and thus, must be replaced frequently.

The sure-grip gripping surface does not rely on the previously used coatings that are negatively affected my moisture, such as perspiration. When coating a bat with a readily available, low-cost, polymeric material (e.g., nylon, polyester, fiberglass) using a UV-curable coating, as is taught in the present invention, the coating is effectively cured in place directly on the underlying substrate in a matter of moments providing for an enhanced, moisture repellant, sure-grip gripping surface that requires no sanding, no heating, and no molding process, where the enhanced surface coating also acts as a reinforcing surface. UV-curing offers advantages of low or zero solvent emissions, high speed curing, and has low-energy requirements—all which provide for a cost-effective and “green” technology.

In general, there are two main types of UV curing systems. The first is by using ethylenically (refers to a double bond between carbons as opposed to a single bond) functional oligomers and monomers which are cross-linked via a photo-initiator that is added to the oligomers and/or monomers and reacts when exposed to UV radiation. When the correct UV frequency shines on the photo-initiator, free radicals are formed that in turn cause the ethylene groups to rapidly polymerize. These types of polymers may be engineered to have high elongation, toughness, hardness, and chemical resistance, as desired.

The second type of UV curing utilizes cationic curing. Here, the curing agent is formed of aliphatic epoxides (single bonds), various polyols, and a photo-initiator. A superacid is formed once the photo-initiator is exposed to UV radiation which begins the polymerization process.

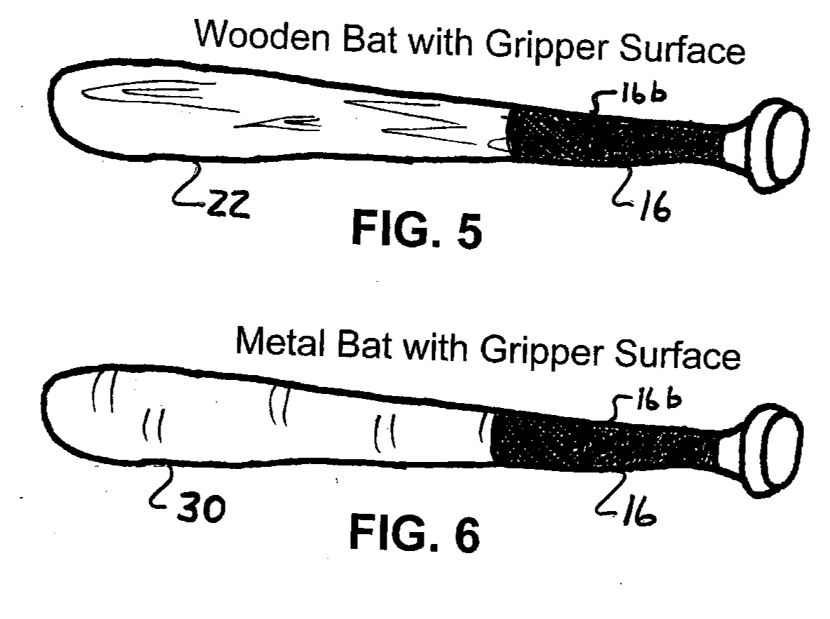

Moreover, the objects benefiting from being provided with an extremely durable, sure-grip gripping surface may be any objects made of any material including metal, and may have a strengthened or un-strengthened surface. FIG. 4, as mentioned above, illustrates a baseball bat strengthened by metallicization benefiting from a sure-grip gripping surface 16 where UV-curable coating 16b secures sure-grip surface 16 onto gripping surface area 14 (see FIG. 3). Another example, illustrated in FIG. 5 a plan view of a conventional wooden bat, depicts wooden bat 22 with the benefit of an enhanced sure-grip gripping surface coating 16 where a nearly instantaneous UV energy cure of a UV-curable coating 16b applied over a polymeric material after it has been enveloped about a gripping surface of an object secures an enhanced, highly frictional sure-grip surface coating 16 onto gripping surface area. FIG. 5, a partial perspective view of a conventional metal bat, depicts aluminum bat 30 benefiting from sure-grip gripping surface coating 16 where UV-curable coating 16b secures sure-grip surface coating 16 onto gripping surface area 14.

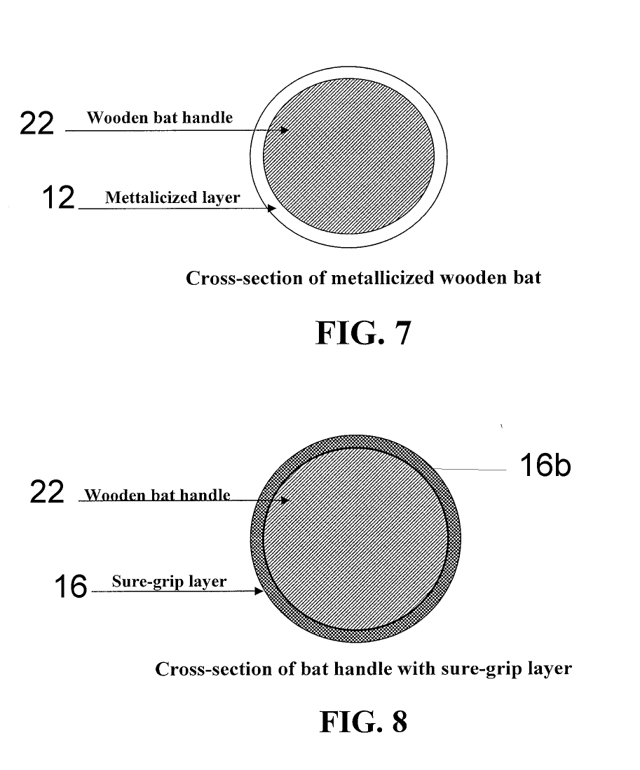

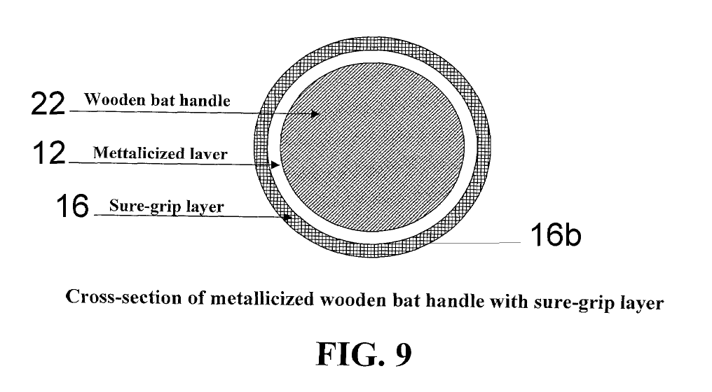

FIG. 7, a cross-section view of a metallicized wooden bat, is used to illustrate the thinness of the metallicizing layer of metal powder paint that has been applied to an otherwise conventional wooden bat. FIG. 8 illustrates a cross-sectional view of an untreated wooden bat handle with a sure-grip gripper surface where UV-curable coating 16b secures sure-grip surface coating 16 onto gripping surface area, whereas FIG. 9 illustrates a cross-sectional view of a metallicized bat with a sure-grip gripper surface applied over the metallicized layer, where UV-curable coating 16b secures sure-grip surface coating 16 onto gripping surface area.

A favored embodiment of an object to be made stronger, which here is a wooden bat strengthened by metallicizing using a metal powder paint and having a moisture-repellent sure-grip gripping surface may be prepared according to the following process. The first step comprises coating the wood using a primer/sealer of aqueous polyurethane dispersion resin to fill in any large voids in the wood. When thoroughly dried, the coated wood may be sanded until smooth to provide for a more uniform surface. In this embodiment, a rapidly drying primer/sealer is used, so that the bat is ready for sanding soon after the primer/sealer is applied. This minimizes rising of the grain and prevents gumming of an otherwise wet finish, where gumming is caused by fine-sized wood particles, produced during the sanding process, adhering to not completely dried finish. A preferred method of application of the primer/sealer is by spraying, but, of course, any known, or yet to be known, application method may be used. The next step is the application of the metallicized finish. For this example, small particle-sized stainless steel flakes are thoroughly mixed in with a coating material, such as paint and applied by again utilizing a spraying technique. The use of small-sized flake-shaped particles provides for a harder surface for the barrel of the bat. Any desired color may be used so that bats may be prepared to match the colors of the team using the bat. At the completion of this step, the wooden bat looks like a metal bat and is now much stronger than an untreated wooden bat. The next step is to provide the now metallicized bat with a sure-grip gripping surface. This is done by placing polymeric material around the gripping area of the bat's handle part. The polymeric material may be nylon, polyester, fiberglass, or other mesh, synthetic or natural material. A UV-curable substance is then applied over the polymeric material. In this embodiment a foam brush may be used to apply the UV-curable substance over the polymeric-material covered part of the bat handle. The polymeric material coated with the UV-curable substance is then exposed to UV radiation for curing. For this embodiment, a high intensity medium pressure mercury lamp (200-300 watts/inch) is used. The sure-grip gripping surface and handle reinforcement so made, provides for a comfortable gripping surface as well as strengthening the handle. The final step in this example is to apply a UV-clear coat over the entire bat to seal, harden, and encase any desired decals, colors, and/or polymeric materials, and to cover any engraved surfaces.

Any object that is strengthened according to the teachings herein is used in the same manner in which the object would be used before it was strengthened. The important difference is that the use is a safer use after strengthening. Similarly, any object that is benefiting from an application of a sure-grip gripping area is used in the same manner in which the object would be used before the sure-grip gripping surface was applied. And, similarly, the important difference is that the use is a safer use when the grip is a sure-grip. The objects that benefit from being strengthened and/or having a sure-grip surface applied are limited only by one's imagination and include, but are not limited to: sports handles—baseball and softball bats, boat oars, tennis rackets, racquetball rackets, hockey sticks, lacrosse, polo, badminton, table tennis, golf, mini golf, racing flags, tools, such as hammers, screwdrivers, rakes, hoes, shovels, sockets sets, ladder rungs and the like, canes, walkers, walking sticks, umbrellas, pointers. Other surfaces that may benefit from the extremely durable, sure-grip surface of the present invention include standing surfaces of snowboards, surf boards, etc., physical fitness equipment, such as weights, including free weights and weight bars, handles on weight machines, ski machine poles, and treadmill grips, etc.

The foregoing description, for purposes of explanation, uses specific and defined nomenclature to provide a thorough understanding of the invention. However, it will be apparent to one skilled in the art that the specific details are not required in order to practice the invention. Thus, the foregoing descriptions of specific embodiments of the present invention were presented for purposes of illustration and description. They are not intended to be exhaustive or to limit the invention to the precise forms disclosed. Those skilled in the art will recognize that many changes may be made to the features, embodiments, and methods of making the embodiments of the invention described herein without departing from the spirit and scope of the invention. Furthermore, the present invention is not limited to the described methods, embodiments, features or combinations of features but include all the variation, methods, modifications, and combinations of features within the scope of the appended claims. The invention is limited only by the claims.

What is claimed is:

1. A method of providing for an enhanced sure grip gripping surface over a gripping area of the object, the method comprising the steps of:
a) providing for an object having a gripping area,
b) performing the following three steps in the order listed:
i) enveloping a polymeric nylon fiber material about the gripping area of the object,
ii) coating said enveloping polymeric nylon fiber material with an ultraviolet-curable liquid polymer, and
iii) curing in less than one second said ultraviolet-curable liquid polymer coating said polymeric nylon fiber material using ultraviolet radiation to create a polymerized coating permanently bonded to the gripping area, said polymerized coating providing for an enhanced high-friction, moisture repellent, sure-grip gripping surface.

2. The method, as recited in claim 1, wherein said polymeric nylon fiber further comprises a composite material consisting of nylon and Spandex.

3. The method, as recited in claim 2, wherein said composite material further comprises a tubular nylon and Spandex material.

4. The method, as recited in claim 1, wherein said polymeric nylon fiber further comprises a tubular nylon material.

5. The method, as recited in claim 1, wherein said object is a wooden object.

6. The method, as recited in claim 1, wherein said object is a metal object.

7. The method, as recited in claim 1, wherein said object is a plastic object.

8. The method, as recited in claim 5, wherein said object is a wooden baseball bat.

9. The method, as recited in claim 6, wherein said object is a metal baseball bat.

10. An object having an enhanced sure grip gripping surface over a gripping area of the object, comprising:
an object having a gripping area,
a polymeric nylon fiber material enveloping the gripping area,
an ultraviolet-curable liquid polymer coating said enveloping polymeric nylon fiber material,
said ultraviolet-curable liquid polymer coating said polymeric nylon fiber material cured in less than one second using ultraviolet radiation creating a sure grip polymerized coating permanently bonded to the gripping area, said polymerized coating providing for an enhanced high-friction, moisture repellent, sure-grip gripping surface.

11. The object, as recited in claim 10, wherein said polymeric nylon fiber further comprises a composite material consisting of nylon and Spandex.

12. The method, as recited in claim 11, wherein said composite material further comprises a tubular nylon and Spandex material.

13. The method, as recited in claim 10, wherein said polymeric nylon fiber further comprises a tubular nylon material.

14. The object, as recited in claim 10, wherein said object is a wooden object.

15. The object, as recited in claim 10, wherein said object is a metal object.

16. The object, as recited in claim 10, wherein said object is a plastic object.

17. The object, as recited in claim 10, wherein said object is a baseball bat.

18. The object, as recited in claim 14, wherein said object is a wooden baseball bat.

19. The object, as recited in claim 15, wherein said object is a metal baseball bat.

20. The method of coating a gripping surface consisting of first enveloping the gripping surface with nylon/spandex composite fabric, then adding a coating of UV-curable liquid polymer to the enveloping nylon/spandex composite fabric, subjecting said UV-curable liquid polymer coated nylon/spandex composite fabric for about one second to UV-energy to provide for an enhanced high-friction, moisture repellent, sure-grip gripping surface.
